(19) United States
(12) Patent Application Publication
(10) Pub. No.: US 2022/0064496 A1
(43) Pub. Date: Mar. 3, 2022

(54) HEAT-RESISTANT LAMINATE AND HEAT-RESISTANT ADHESIVE

(71) Applicant: 3M INNOVATIVE PROPERTIES COMPANY, St. Paul, MN (US)

(72) Inventors: Shunsuke Suzuki, Tokyo (JP); Alejandro Aldrin II A. Narag, Singapore (SG)

(21) Appl. No.: 17/418,410

(22) PCT Filed: Dec. 23, 2019
(86) PCT No.: PCT/IB2019/061300

§ 371 Date: Jun. 25, 2021

(30) Foreign Application Priority Data
Dec. 26, 2018 (JP) 2018-243356

(51) Int. Cl. C09J 7/38; C09J 7/29; C09J 9/00; C09J 133/06; C09J 133/02; C09J 133/08; C08L 93/04; C08K 5/3412

(52) U.S. Cl. CPC C09J 7/385; C09J 7/29; C09J 9/00; C09J 133/068; C09J 133/02; C09J 133/08; C09J 2301/408; C08K 5/3412; C09J 2467/00; C09J 2479/00; C09J 2301/162; C09J 2301/124; C08L 93/04

(57) ABSTRACT

A heat-resistant laminate including a substrate and an adhesive layer, the adhesive layer including a (meth)acrylic adhesive polymer and a self-crosslinking (meth)acrylic copolymer having an epoxy group and an epoxy group-reactive functional group, the adhesive layer having a sea-island structure including a sea including the (meth)acrylic adhesive polymer and an island including the self-crosslinking (meth)acrylic copolymer, and the laminate having a 180 degree peeling force of 0.9 N/cm or more after bonding to a SUS board and leaving at 120° C. for 30 minutes as measured at a temperature of 60° C. and a peeling speed of 300 mm/min.

### TECHNICAL FIELD

The present disclosure relates to a heat-resistant laminate and a heat-resistant adhesive.

### BACKGROUND ART

In the production of various types of electronic components, heat treatment steps are commonly performed and several times of heat treatment at 100° C. or higher may be performed for solidifying and aging of materials. An adhesive tape having heat resistance, which may be referred to as a process tape, is used for the purpose of fixing workpieces such as epoxy resin-encapsulated silicon wafers and plastic resin laminated copper plates included in electronic components to the work surface in the equipment during heat treatment, and transporting after heat treatment as necessary. The process tape is removed from the workpiece after the heat treatment is completed.

Patent Document 1 (Japanese Unexamined Patent Application Publication No. 2006-302941) describes a double-sided adhesive tape including a core material made of a nonwoven fabric having a thickness of 20 μm or less, and an adhesive layer including an acrylic polymer having a glass transition point (Tg) of from −20° C. to 20° C. and a weight average molecular weight of 1,000,000 or more disposed on both surfaces of the core material, the total thickness of the double-sided adhesive tape being 60 μm or less”.

Patent Document 2 (Japanese Unexamined Patent Application 2007-302868) discloses a double-sided adhesive tape or sheet used for printed circuit boards, the pressure-sensitive adhesive layer being formed of an adhesive composition composed mainly of an acrylic polymer and containing a chain transfer substance, and having an initial gel fraction of from 40 to 70% by weight, the difference between the gel fraction (% by weight) after the solder reflow process under a predetermined heat treatment conditions and the initial gel fraction (% by weight) being 10 or less.

Patent Document 3 (Japanese Unexamined Patent Application 2005-053975) discloses a heat-resistant masking tape including (1) a heat-resistant backing film layer and (2) an adhesive layer disposed on the heat-resistant backing layer, the adhesive layer including alkyl (meth)acrylate having 4 to 15 carbon atoms, glycidyl (meth)acrylate, and (meth)acrylic acid, and includes a polymer obtained by polymerizing and crosslinking a monomer mixture including 2 to 13% by mass of the glycidyl (meth)acrylate based on the total mass of the monomers and 1 to 7% by mass of the (meth)acrylic acid based on the total mass of the monomers.

### CITATION LIST

Patent Document 1: JP 2006-302941 A

Patent Document 2: JP 2007-302868 A

Patent Document 3: JP 2005-053975 A

### SUMMARY OF INVENTION

In workpieces such as an epoxy resin-encapsulated silicon wafers and plastic resin laminated copper plates, materials having different chemical properties are laminated and integrated. A laminate of such different materials cause peeling or large warpage during or after heat treatment due to the difference in the thermal expansion coefficient of the material constituting the laminate, and the end or center of the laminate may peel off from the work surface such as SUS or quartz glass. In order to suppress peeling or large warping of the laminate during production of an electronic component, there is a desire for a process tape that can fix the adherend to the work surface with high adhesive strength even at high temperatures and can be easily removed after heat treatment.

The present disclosure provides a heat-resistant laminate and a heat-resistant adhesive that are compatible with a high temperature heat treatment step (e.g., up to 270° C.) and can be easily removed from an adherend after heat treatment, and can reduce or eliminate adhesive residue on the adherend after removal.

### Solution to Problem

One embodiment provides a heat-resistant laminate including a substrate and an adhesive layer, the adhesive layer including: a (meth)acrylic adhesive polymer and a self-crosslinking (meth)acrylic copolymer having an epoxy group and an epoxy group-reactive functional group, the adhesive layer having a sea-island structure including a sea including the (meth)acrylic adhesive polymer and an island including the self-crosslinking (meth)acrylic copolymer, and the laminate having a 180 degree peeling force of 0.9 N/cm or more after being adhered to a SUS board and left at 120° C. for 30 minutes as measured at a temperature of 60° C. and a peeling speed of 300 mm/min.

Another embodiment provides a heat-resistant laminate including a substrate and an adhesive layer, the adhesive layer including a (meth)acrylic adhesive polymer, a self-crosslinking (meth)acrylic copolymer having an epoxy group and an epoxy group-reactive functional group, and a tackifier having an epoxy group-reactive functional group, the adhesive layer having a sea-island structure including a sea including the (meth)acrylic adhesive polymer and an island including the self-crosslinking (meth)acrylic copolymer.

Yet another embodiment provides a heat-resistant adhesive including a (meth)acrylic adhesive polymer, a self-crosslinking (meth)acrylic copolymer having an epoxy group and an epoxy group-reactive functional group, and a tackifier having an epoxy group-reactive functional group, the adhesive forming a sea-island structure including a sea including the (meth)acrylic adhesive polymer and an island including the self-crosslinking (meth)acrylic copolymer when solidified or dried on a substrate.

### Advantageous Effects of Invention

The heat-resistant laminate and the heat-resistant adhesive of the present disclosure are suitable for heat treatment steps at high temperatures (for example, up to 270° C.), and can be easily removed from the adherend after heat treatment, and thus can reduce or eliminate the adhesive residue on the adherend after removal.

The above descriptions should not be construed that all embodiments of the present invention and all advantages of the present invention are disclosed.

### BRIEF DESCRIPTION OF DRAWINGS

FIG. 1 is a schematic cross-sectional view of a heat-resistant laminate according to one embodiment.

FIG. 2 is a schematic cross-sectional view of a heat-resistant laminate of another embodiment.

### DESCRIPTION OF EMBODIMENTS

Although representative embodiments of the present invention will now be described in more detail for the purpose of illustration with reference to the Figure, the present invention is not limited to these embodiments.

In the present disclosure, the “film” includes an article referred to as a “sheet”.

In the present disclosure, the term “pressure-sensitive adhesiveness” means a property of a material or composition permanently having adhesiveness within a range of the operation temperature, for example, within a range of from 0° C. to 50° C., and being capable of adhering to various surfaces under slight pressure without undergoing phase transition (from liquid to solid).

In the present disclosure, “(meth)acrylic” means acrylic or methacrylic, and “(meth)acrylate” means acrylate or methacrylate.

The heat-resistant laminate in one embodiment includes a substrate and an adhesive layer. The adhesive layer includes a (meth)acrylic adhesive polymer and a self-crosslinking (meth)acrylic copolymer having an epoxy group and an epoxy group-reactive functional group (which may be referred to simply as “self-crosslinking (meth)acrylic copolymer” in the present disclosure), and has a sea-island structure including a sea including the (meth)acrylic adhesive polymer and an island including the self-crosslinking (meth)acrylic copolymer.

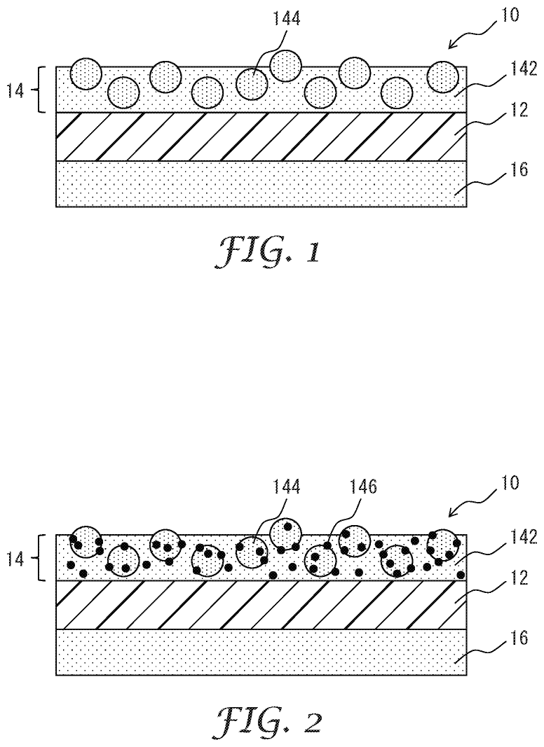

FIG. 1 illustrates a schematic cross-sectional view of a heat-resistant laminate of one embodiment. The heat-resistant laminate 10 includes a substrate 12 and an adhesive layer 14. The adhesive layer 14 has a sea-island structure including a sea 142 including a (meth)acrylic adhesive polymer and an island 144 including a self-crosslinking (meth)acrylic copolymer. The substrate 12 may have an optional second adhesive layer 16 on the surface opposite to the surface on which the adhesive layer 14 is disposed. In FIG. 1, the heat-resistant laminate 10 is depicted as a double-sided adhesive laminate.

Examples of the substrate include films or their laminates including polyesters such as polyethylene terephthalate and polyethylene naphthalate, acrylic resins such as polyurethane, polyimide, polycarbonate, polyether ether ketone, polyphenylene sulfide, polyether sulfone, polyethylene sulfide, polyphenylene ether, and polymethyl methacrylate, or fluorine resins such as polyvinylidene fluoride, polytetrafluoroethylene, and polychlorinated ethylene trifluoride; paper such as kraft paper or Japanese paper; woven or non-woven fabrics including polyester fiber, polyamide fiber, or carbon fiber; rubber sheets including natural rubber or butyl rubber; foam sheets including polyurethane or polychloroprene rubber; metal foil such as aluminum foil or copper foil; and composite materials thereof.

The substrate preferably has a glass transition temperature of about 100° C. or higher, about 110° C. or higher, or about 120° C. or higher. Due to the glass transition temperature of the substrate being about 100° C. or higher, deformation of the substrate during heat treatment can be suppressed, and the adherend can be stably fixed. In one embodiment, the glass transition temperature of the substrate is about 300° C. or lower, about 250° C. or lower, or about 200° C. or lower.

From the perspective of heat resistance, availability, and handleability, the substrate is preferably a film of polyethylene terephthalate, polyethylene naphthalate, polyimide, polyethersulfone, or polyphenylene sulfide, and more preferably a polyimide film in applications where higher heat resistance is required.

The substrate may be transparent, translucent, or opaque.

For the purpose of improving the adhesion with the adhesive layer or the second adhesive layer, surface treatment such as corona discharge treatment, plasma treatment, chromate treatment, flame treatment, ozone treatment, or sand blasting may be performed, and a primer layer may be formed on one or both surfaces of the substrate.

The substrate may be subjected to release treatment. In this embodiment, the substrate functions as a release liner, and after affixing one surface of the adhesive layer of the heat-resistant laminate to the adherend or the surface to which the adherend is fixed, the substrate is removed, and the exposed other surface of the adhesive layer is affixed to the adherend or the surface to which the adherend is fixed, thereby bonding the adherend and the surface to which the adherend is fixed via the adhesive layer. The release treatment can be performed by applying or impregnating a release agent including silicone, a long-chain alkyl compound, a fluorine compound, or the like on the substrate.

The thickness of the substrate may be generally about 5 μm or more, 10 μm or more, or about 20 μm or more, and about 1 mm or less, about 500 μm or less, or about 250 μm or less.

The adhesive layer can be formed by applying a heat-resistant adhesive including a (meth)acrylic adhesive polymer, a self-crosslinking (meth)acrylic copolymer, and, as necessary, a crosslinking agent, a tackifier, an additive, a solvent, and the like to a substrate by bar coating, blade coating, doctor coating, roll coating, cast coating, melt extrusion, or the like, followed by solidifying or drying. The heat-resistant adhesive may of solvent type, solvent-free type, or hot melt type. When the heat-resistant adhesive is solidified or dried on the substrate, a sea-island structure composed of a sea including a (meth)acrylic adhesive polymer and an island including a self-crosslinking (meth)acrylic copolymer is formed. Solidification includes curing of the heat-resistant adhesive by heating, UV irradiation, or the like, and coagulation by cooling the hot melt heat-resistant adhesive. Drying includes solvent volatilization.

It is advantageous that the adhesive layer is a pressure-sensitive adhesive layer in terms of workability.

The (meth)acrylic adhesive polymer is composed mainly of the sea of the sea-island structure. The (meth)acrylic adhesive polymer may be included in the island of the sea-island structure. The (meth)acrylic adhesive polymer provides an adhesive strength that is a base necessary for holding the adherend when it is applied to the adhesive layer of the adherend, during heat treatment, and after cooling.

The (meth)acrylic adhesive polymer can be obtained by polymerizing or copolymerizing a composition that includes a monomer having a (meth)acrylic monomer and, as necessary, other monoethylenically unsaturated groups. In the present disclosure, (meth)acrylic monomers and other monomers having a monoethylenically unsaturated group are collectively referred to as polymerizable components. An adhesive polymer means a polymer capable of imparting pressure-sensitive adhesion to an adhesive at a use temperature (for example, 0° C. or higher and 50° C. or lower). The (meth)acrylic monomer and other monomer having a monoethylenically unsaturated group may be used alone or in combination of two or more.

The (meth)acrylic monomer generally includes an alkyl (meth)acrylate. The number of carbon atoms in the alkyl group of the alkyl (meth)acrylate may be from 1 to 12. Examples of the alkyl (meth)acrylate include methyl (meth)acrylate, ethyl (meth)acrylate, n-butyl (meth)acrylate, isobutyl (meth)acrylate, isoamyl (meth)acrylate, n-hexyl (meth)acrylate, n-octyl (meth)acrylate, isooctyl (meth)acrylate, 2-ethylhexyl (meth)acrylate, isononyl (meth)acrylate, decyl (meth)acrylate, isodecyl (meth)acrylate, dodecyl (meth)acrylate, cyclohexyl (meth)acrylate, 4-t-butylcyclohexyl (meth) acrylate, and isobornyl (meth)acrylate. In one embodiment, as alkyl (meth)acrylate, n-butyl acrylate, 2-ethylhexyl acrylate, isooctyl acrylate, dodecyl acrylate, isobornyl (meth)acrylate, or mixtures thereof are used. These monomers can impart initial tackiness to the adhesive layer.

The (meth)acrylic monomer or another monomer having a monoethylenically unsaturated group may include a polar monomer copolymerizable with alkyl (meth)acrylate. Examples of the polar monomer include: carboxy group-containing monomers such as (meth)acrylic acid, monohydroxyethyl phthalate (meth)acrylate, β-carboxyethyl (meth)acrylate, 2-(meth)acryloyloxyethyl succinic acid, 2-(meth)acryloyloxyethylhexahydrophthalic acid, crotonic acid, itaconic acid, fumaric acid, citraconic acid, and maleic acid; amino group-containing monomers such as aminoethyl (meth)acrylate, N,N-dimethylaminoethyl (meth)acrylate, and butylaminoethyl (meth)acrylate; amide group-containing monomers such as (meth)acrylamide, N-vinylpyrrolidone, and N-vinylcaprolactam; hydroxyl group-containing monomers such as 2-hydroxyethyl (meth)acrylate, 2-hydroxypropyl (meth)acrylate, and 4-hydroxybutyl (meta)acrylate; and (meth) unsaturated nitriles such as acrylonitrile. These polar monomers can increase the cohesive strength of the adhesive layer and improve the adhesive strength.

In one embodiment, the (meth)acrylic adhesive polymer is a copolymer of a composition including about 2% by mass or more, about 5% by mass or more, or about 8% by mass or more, and about 50% by mass or less, about 40% by mass or less, and about 30% by mass or less of a polar monomer based on the polymerizable component.

The (meth)acrylic monomer or another monomer having a monoethylenically unsaturated group may include an epoxy group-containing monomer. Example of the epoxy group-containing monomer include glycidyl (meth)acrylate.

Examples of the other monomer having a monoethylenically unsaturated group include aromatic vinyl monomers such as styrene, α-methylstyrene, and vinyltoluene; and vinyl esters such as vinyl acetate.

The (meth)acrylic adhesive polymer may have at least one type of epoxy group-reactive functional group selected from a carboxy group, a hydroxyl group, and an amino group. The epoxy group-reactive functional group of the (meth)acrylic adhesive polymer reacts with the epoxy groups of the self-crosslinking (meth)acrylic copolymer, which is present in the island of the sea-island structure, or may be present in the sea of the sea-island structure, to increase the cohesive strength of the sea-island interface or the sea part of the sea-island structure during heat treatment. As a result, the heat resistance of the entire adhesive layer can be further increased. The epoxy group-reactive functional group can be introduced into the (meth)acrylic adhesive polymer by copolymerizing a carboxy group-containing monomer, a hydroxyl group-containing monomer, or an amino group-containing monomer, or amide group-containing monomer having active hydrogen on a nitrogen atom such as aminoethyl (meth)acrylate, butylaminoethyl (meth)acrylate or (meth)acrylamide, which is a monomer having an epoxy group-reactive functional group, with acryl (meth)acrylate.

In one embodiment, the (meth)acrylic adhesive polymer is a copolymer of a composition including about 50% by mass or more and about 98% by mass or less of alkyl (meth)acrylate and about 2% by mass or more of a monomer having an epoxy group-reactive functional group based on the polymerizable component. In the composition, the content of the alkyl (meth)acrylate may be about 60% by mass or more, or about 70% by mass or more, and about 95% by mass or less, or about 92% by mass or less, and the content of the monomer having an epoxy group-reactive functional group may be about 5% by mass or more, or about 8% by mass or more, and about 50% by mass or less, about 40% by mass or less, or about 30% by mass or less based on the polymerizable component.

In one embodiment, the acid value of the (meth)acrylic adhesive polymer is about 30 mgKOH/g or more, about 35 mgKOH/g or more, or about 40 mgKOH/g or more, and about 100 mgKOH/g or less, about 90 mgKOH/g or less, or about 80 mgKOH/g or less. By setting the acid value of the (meth)acrylic adhesive polymer to about 30 mgKOH/g or more, the reactivity of the (meth)acrylic adhesive polymer with the epoxy group of the self-crosslinking (meth)acrylic copolymer can be increased. By setting the acid value of the (meth)acrylic adhesive polymer to be about 100 mgKOH/g or less, the cohesive strength of the adhesive layer can be set to an appropriate range, and deterioration of the adhesive layer due to the presence of acidic groups, particularly deterioration in a high temperature environment can be suppressed. The acid value of the (meth)acrylic adhesive polymer can be determined by potentiometric titration using 0.1 M alcoholic potassium hydroxide as a titration reagent.

The weight average molecular weight of the (meth)acrylic adhesive polymer is preferably high enough to phase separate from the self-crosslinking (meth)acrylic copolymer to form a sea-island structure. In one embodiment, the weight average molecular weight of the (meth)acrylic adhesive polymer is about 300,000 or more, preferably about 600,000 or more, and more preferably about one million or more. Such a high molecular weight (meth)acrylic adhesive polymer can advantageously increase the heat resistance of adhesion. In one embodiment, the weight average molecular weight of the (meth)acrylic adhesive polymer is about 5,000,000 or less, about 4,000,000 or less, or about 3,000,000 or less. In the present disclosure, “weight average molecular weight” means a molecular weight converted to standard polystyrene by a gel permeation chromatography (GPC) method.

In one embodiment, the (meth)acrylic adhesive polymer does not have an epoxy group. As a result, compatibility of the (meth)acrylic adhesive polymer with the self-crosslinking (meth)acrylic copolymer is reduced, and the formation of the sea-island structure can be further promoted.

In one embodiment, the glass transition temperature (Tg) of the (meth)acrylic adhesive polymer is about −30° C. or higher, about −10° C. or higher, or about 0° C. or higher, and about 50° C. or lower, or about 25° C. or lower. When the Tg is within the above range, sufficient cohesive strength and adhesion can be imparted to the adhesive layer in the use temperature range of the heat-resistant laminate.

The glass transition temperature Tg (° C.) of the (meth)acrylic adhesive polymer can be determined by the following the FOX equation, where the polymer is copolymerized from n types of monomers:

$$\frac{1}{Tg + 273.14} = {\sum }_{i = 1}^{n} ( \frac{{X}_{i}}{{Tg}_{i} + 273.15} ) \qquad [ Formula 1 ]$$

Wherein Tgi represents the glass transition temperature (° C.) of the homopolymer of the component i, Xᵢ represents the mass fraction of the monomer of the component i added during polymerization, and i is a natural number of 1 to n.

$${\sum }_{i = 1}^{n} {X}_{i} = 1 \qquad [ Formula 2 ]$$

The polymerization or copolymerization of the (meth)acrylic adhesive polymer can be performed by radical polymerization, and known polymerization methods such as solution polymerization, suspension polymerization, emulsion polymerization, and bulk polymerization can be used. It is advantageous to use solution polymerizations that can readily synthesize high molecular weight polymers. Examples of the polymerization initiator include organic peroxides such as benzoyl peroxide, lauroyl peroxide, and bis(4-tert-butylcyclohexyl) peroxydicarbonate; and azo-based polymerization initiators such as 2,2′-azobisisobutyronitrile, 2,2′-azobis(2-methylbutyronitrile), dimethyl-2,2-azobis (2-methylpropionate), 4,4′-azobis(4-cyanovaleric acid), 2,2′-azobis (2-methylpropionic acid) dimethyl, and azobis (2,4-dimethylvaleronitrile) (AVN). The usage of the polymerization initiator is generally about 0.01 parts by mass or more, about 0.05 parts by mass or more, and about 5 parts by mass or less, or about 3 parts by mass or less with reference to 100 parts by mass of the polymerizable component.

The self-crosslinking (meth)acrylic copolymer having an epoxy group and an epoxy group-reactive functional group mainly constitutes the island of the sea-island structure. The self-crosslinking (meth)acrylic copolymer may be included in the sea of the sea-island structure.

When the self-crosslinking (meth)acrylic copolymer is placed in a high temperature environment such as heat treatment, the epoxy group reacts with the epoxy group-reactive functional group to form a cross-linked structure (self-crosslinking) in one molecule of the self-crosslinking (meth)acrylic copolymer or between the molecules of the self-crosslinking (meth)acrylic copolymer. The self-crosslinking (meth)acrylic copolymer may not be crosslinked or may be partially crosslinked before the heat treatment of the heat-resistant laminate. As the formation of self-crosslinking proceeds in a high-temperature environment, the cohesive strength of the island increases, and as a result, the heat resistance of the entire adhesive layer can be further increased. In addition, due to the presence of island having an increased cohesive strength due to self-crosslinking, the adhesive strength of the adhesive layer decreases in a temperature range lower than the peak temperature of the heat treatment (for example, about 120° C. or lower), and the adherend can be easily removed from the adhesive layer, whereby the adhesive residue on the adherend after removal can be reduced or eliminated.

When the (meth)acrylic adhesive polymer has an epoxy group-reactive functional group, the epoxy group of the self-crosslinking (meth)acrylic copolymer reacts with the epoxy group-reactive functional group of the (meth)acrylic adhesive polymer, which is present in the sea part or may be present in the island part of the sea-island structure, during the heat treatment, and increases the cohesive strength of the sea-island interface or island part of the sea-island structure. As a result, the heat resistance of the entire adhesive layer can be further increased.

The self-crosslinking (meth)acrylic copolymer can be obtained, in the same manner as the (meth)acrylic adhesive polymer, by copolymerizing a composition including a (meth)acrylic monomer and another monomer having a monoethylenically unsaturated group. The (meth)acrylic monomer and other monomer having a monoethylenically unsaturated group may be used alone or in combination of two or more of them.

The (meth)acrylic monomer generally includes an alkyl (meth)acrylate. The number of carbon atoms in the alkyl (meth)acrylate may be from 1 to 12. Examples of the alkyl (meth)acrylate include methyl (meth)acrylate, ethyl (meth)acrylate, n-butyl (meth)acrylate, isobutyl (meth)acrylate, isoamyl (meth)acrylate, n-hexyl (meth)acrylate, n-octyl (meth)acrylate, isooctyl (meth)acrylate, 2-ethylhexyl (meth)acrylate, isononyl (meth)acrylate, decyl (meth)acrylate, isodecyl (meth)acrylate, dodecyl (meth)acrylate, cyclohexyl (meth)acrylate, 4-t-butylcyclohexyl (meth)acrylate, and isobornyl (meth)acrylate. In one embodiment, as the alkyl (meth)acrylate, ethyl acrylate, n-butyl acrylate, 2-ethylhexyl acrylate, cyclohexyl acrylate, 4-t-butylcycloacrylate, isobornyl (meth)acrylate, or a mixture thereof is used. These monomers can promote the formation of the sea-island structure, and can also impart initial tackiness to the adhesive layer.

The (meth)acrylic monomer or other monomer having a monoethylenically unsaturated group includes an epoxy group-containing monomer, whereby an epoxy group is introduced into the self-crosslinking (meth)acrylic copolymer. An example of the epoxy group-containing monomer is glycidyl (meth)acrylate.

The (meth)acrylic monomer or another monomer having a monoethylenically unsaturated group includes a monomer having an epoxy group-reactive functional group, whereby an epoxy group-reactive functional group is introduced into the self-crosslinking (meth)acrylic copolymer. Examples of the epoxy group-reactive functional group include a carboxy group, a hydroxyl group, and an amino group.

Examples of the monomer having an epoxy group-reactive functional group include carboxy group-containing monomers such as (meth)acrylic acid, monohydroxyethyl phthalate (meth)acrylate, β-carboxyethyl (meth)acrylate, 2-(meth)acryloyloxyethyl succinic acid, 2-(meth)acryloyloxyethylhexahydrophthalic acid, crotonic acid, itaconic acid, fumaric acid, citraconic acid, and maleic acid; hydroxyl group-containing monomers such as hydroxyalkyl (meth)acrylates such as 2-hydroxyethyl (meth)acrylate, 2-hydroxypropyl (meth)acrylate and 4-hydroxybutyl (meth)acrylate; and amino group-containing monomers or amide group-containing monomers having active hydrogen on nitrogen atom, such as aminoethyl (meth)acrylate, butylaminoethyl (meth)acrylate, and (meth)acrylamide. From the perspective of control of reactivity with an epoxy group, high adhesive strength to the substrate, and high cohesive strength, it is advantageous to use (meth)acrylic acid.

The epoxy group itself can also function as an epoxy group-reactive functional group.

(Meth)acrylic monomers or other monomers having a monoethylenically unsaturated group may include dialkylamino group-containing monomers such as N,N-dimethylaminoethyl (meth)acrylate; N-substituted amide group-containing monomers such as N-vinylpyrrolidone and N-vinylcaprolactam; unsaturated nitriles such as (meth)acrylonitrile; aromatic vinyl monomers such as styrene, α-methylstyrene, and vinyltoluene; or vinyl esters such as vinyl acetate.

In one embodiment, the self-crosslinking (meth)acrylic copolymer is a copolymer of a composition including about 50% by mass or more and about 98% by mass or less of alkyl (meth)acrylate, about 1% by mass or more of an epoxy group-containing monomer, and about 1% by mass or more of a monomer having an epoxy group-reactive functional group based on a polymerizable component. However, the content of the monomer having an epoxy group-reactive functional monomer does not include the epoxy group-containing monomer. In the composition, based on the polymerizable component, the content of alkyl (meth)acrylate may be about 60% by mass or more or about 70% by mass or more, and about 95% by mass or less or about 92% by mass or less, and the epoxy group-containing monomer may be about 2% by mass or more or about 4% by mass or more, and about 25% by mass or less, about 20% by mass or less, or about 15% by mass or less. The content of the monomer having an epoxy group-reactive functional group may be about 2% by mass or more, about 4% by mass or more, and about 25% by mass or less, about 20% by mass or less, or about 15% by mass or less.

The weight average molecular weight of the self-crosslinking (meth)acrylic copolymer is preferably high enough to phase separate from the (meth)acrylic adhesive polymer to form a sea-island structure. In one embodiment, the weight average molecular weight of the self-crosslinking (meth)acrylic copolymer is about 100,000 or more, preferably about 300,000 or more, and more preferably about 500,000 or more. Such a high molecular weight self-crosslinking (meth)acrylic copolymer can advantageously increase heat resistance of adhesion. In one embodiment, the weight average molecular weight of the self-crosslinking (meth)acrylic copolymer is about 2,000,000 or less, about 1,800,000 or less, or about 1,500,000 or less.

In one embodiment, the glass transition temperature (Tg) of the self-crosslinking (meth)acrylic copolymer is about −30° C. or higher, about −10° C. or higher, or about 0° C. or higher, and about 100° C. or lower, about 50° C. or lower, or about 25° C. or lower. When the Tg is within the above range, sufficient cohesive strength and adhesion can be imparted to the adhesive layer in the use temperature range of the heat-resistant laminate. When the Tg of the self-crosslinking (meth)acrylic copolymer is higher than about 100° C., sufficient cohesive strength and adhesion can be imparted to the adhesive layer by mixing the copolymer with the (meth)acrylic adhesive polymer having a Tg of about 25° C. or lower to cause phase separation. The glass transition temperature Tg (° C.) of the self-crosslinking (meth)acrylic copolymer can be determined using the FOX equation in the same manner as that of the (meth)acrylic adhesive polymer.

The copolymerization of the self-crosslinking (meth)acrylic copolymer can be performed by radical polymerization, and may use a known polymerization method such as solution polymerization, suspension polymerization, emulsion polymerization, or bulk polymerization. It is advantageous to use solution polymerizations that can readily synthesize high molecular weight polymers. The type and usage of the polymerization initiator are the same as those described for the (meth)acrylic adhesive polymer.

In order to reduce the compatibility between the (meth)acrylic adhesive polymer and the self-crosslinking (meth)acrylic copolymer to a degree suitable for the formation of a sea-island structure, their compositions, weight average molecular weights, and blending ratio may be adjusted. The sea may or may not include a self-crosslinking (meth)acrylic copolymer as long as it dissolves in the (meth)acrylic adhesive polymer. The island may or may not include a (meth)acrylic adhesive polymer as long as the island is formed.

In one embodiment, the mass ratio of the (meth)acrylic adhesive polymer to the self-crosslinking (meth)acrylic copolymer is from 99:1 to 51:49, preferably from 90:10 to 51:49, and more preferably from 85:15 to 55:45. By setting the mass ratio of the (meth)acrylic adhesive polymer to the self-crosslinking (meth)acrylic copolymer to the above range, the formation of the sea-island structure is promoted.

The (meth)acrylic adhesive polymer and/or the self-crosslinking (meth)acrylic copolymer may be crosslinked with a crosslinking agent. By crosslinking these polymers using a crosslinking agent, the cohesive strength of the adhesive layer can be increased to increase the heat resistance of the adhesive layer, whereby the adhesive strength at high temperatures can be maintained. Examples of the crosslinking agent include bis-amide crosslinking agents such as, 1,1′-isophthaloylbis(2-methylaziridine); aziridine crosslinking agents such as Chemitite (trademark) PZ33 (manufactured by Nippon Shokubai Co., Ltd., Osaka-shi, Osaka, Japan); carbodiimide crosslinking agents such as Carbodilite (trademark) V-03, V-05, and V-07 (all of them are manufactured by Nisshinbo Chemical Inc., Chuo-ku, Tokyo, Japan); epoxy crosslinking agents such as E-AX, E-5XM, and E5C (all of them are manufactured by Soken Chemical & Engineering Co., Ltd., Toshima-ku, Tokyo, Japan), N,N,N′,N′-tetraglycidyl -1,3-benzenedi (methanamine); and isocyanate crosslinking agents such as Coronate (trademark) L, Coronate (trademark) HK (all of them are manufactured by Tosoh Corporation, Minato-ku, Tokyo, Japan).

The usage of the crosslinking agent may be about 0.01 parts by mass or more, about 0.02 parts by mass or more, or about 0.05 parts by mass or more, and about 2 parts by mass or less, about 1.5 parts by mass or less, or about 1 part by mass or less with reference to total 100 parts by mass of the (meth)acrylic adhesive polymer and the self-crosslinking (meth)acrylic copolymer. By setting the usage of the crosslinking agent to be within the above range, the cohesive strength of the adhesive layer can be effectively increased.

The (meth)acrylic adhesive polymer and/or the self-crosslinking (meth)acrylic copolymer may be crosslinked by copolymerization with a crosslinking monomer. The crosslinking increases the cohesive strength of the adhesive layer to increase the heat resistance of the adhesive layer, and maintains the adhesive strength at high temperature. Examples of the crosslinking monomer include multifunctional (meth)acrylates such as 1,6-hexanediol di(meth)acrylate, 1,12-dodecanediol di(meth)acrylate, trimethylolpropane tri(meth)acrylate, pentaerythritol tetra(meth)acrylate, and 1,2-ethylene glycol di(meth)acrylate. Copolymerization with the crosslinking monomer may be performed using a thermal polymerization initiator or a photopolymerization initiator. The copolymerization with the crosslinking monomer may be performed during the preparation of the (meth)acrylic adhesive polymer or the self-crosslinking (meth)acrylic copolymer, or may be performed using the ethylenically unsaturated group remaining in the polymer after preparation of the (meth)acrylic adhesive polymer or the self-crosslinking (meth)acrylic copolymer.

The usage of the crosslinking monomer may be about 0.05 parts by mass or more, about 0.1 parts by mass or more, or about 0.2 parts by mass or more, and about 1 part by mass or less, about 0.8 parts by mass or less, or about 0.5 parts by mass or less with respect to 100 parts by mass of a total of the (meth)acrylic adhesive polymer and the self-crosslinking (meth)acrylic copolymer. By setting the usage of the crosslinking monomer to be within the above range, the cohesive strength of the adhesive layer can be effectively increased.

The adhesive layer may include a tackifier. The use of a tackifier can increase the initial tackiness of the adhesive layer.

As the tackifier, those compatible with at least a (meth)acrylic adhesive polymer, preferably compatible with a (meth)acrylic adhesive polymer and a self-crosslinking (meth)acrylic copolymer can be used. Examples of the tackifier include rosin resins such as disproportionated rosin esters, polymerized rosin esters, and hydrogenated rosin esters derived from a resin acid such as abietic acid, levohimaric acid, or neoabietic acid; terpene resins derived from α-pinene, β-pinene, limonene, and the like; terpen phenol resins, aromatic modified terpene resins, hydrogenated terpene resins, aliphatic (C5) petroleum resins, aromatic (C9) petroleum resins, aliphatic-aromatic (C5-C9) petroleum resins, hydrogenated petroleum resins, coumarone indene resins, phenolic resins, styrene resins, and xylene resins. The tackifier may be used alone or in combination of two or more of them.

In one embodiment, the softening point of the tackifier is about 100° C. or higher, about 130° C. or higher, or about 150° C. or higher. A tackifier having a softening point of about 100° C. or higher can increase the adhesive strength of the adhesive layer even at a temperature higher than room temperature, for example 60° C. When a laminate of different materials is used as an adherend, the amount of warpage gradually increases as the temperature increases from room temperature. According to this embodiment, peeling from the work surface due to warpage of the adherend can be more effectively prevented. In one embodiment, the softening point of the tackifier is about 200° C. or lower, about 190° C. or lower, or about 180° C. or lower. A tackifier having a softening point of about 200° C. or lower can be well dissolved in the acrylic adhesive polymer and optionally in the self-crosslinking (meth)acrylic copolymer. The softening point of the tackifier can be measured using a thermomechanical analyzer (TMA).

The molecular weight of the tackifier is desirably such that the tackifier is well dissolved in the (meth)acrylic adhesive polymer and optionally the self-crosslinking (meth)acrylic copolymer, and may be, for example, about 100,000 or less, or about 50,000 or less.

In one embodiment, the adhesive layer includes a tackifier having an epoxy group-reactive functional group. The tackifier having an epoxy group-reactive functional group functions as a tackifier before heat treatment, and can increase the initial tackiness of the adhesive layer. During heat treatment, the epoxy group-reactive functional group of the tackifier reacts with the epoxy group of a self-crosslinking (meth)acrylic copolymer which is present in the island part of the sea-island structure, or may be present in the sea part of the sea-island structure, to form a chemical bond between the tackifier and the self-crosslinking (meth)acrylic copolymer. This not only further increases the cohesive strength of the adhesive layer, but also suppresses bleeding of the tackifier from the adhesive layer, and effectively reduces or eliminates the adhesive residue on the adherend when the adherend is peeled from the adhesive layer after heat treatment.

FIG. 2 illustrates a schematic cross-sectional view of the heat-resistant laminate of the present embodiment. In FIG. 2, the tackifier 146 having an epoxy group-reactive functional group is shown as a black circle as a molecule, but the tackifier 146 is dissolved or dispersed in the adhesive layer 14. The tackifier 146 forms a chemical bond with the self-crosslinking (meth)acrylic copolymer of the island 146 or of the sea 142 during heat treatment, and is fixed to the adhesive layer.

The epoxy group-reactive functional group of the tackifier may be at least one type selected from carboxy groups, hydroxyl groups, amino groups, and epoxy groups. Examples of the tackifier having an epoxy group-reactive functional group include rosin resins (carboxy groups), terpene phenol resins, phenol resins (hydroxyl groups), and amino and epoxy modifications of the above tackifier.

From the perspective of availability, tackifying performance, and reactivity with epoxy groups, rosin resins are advantageously used. In one embodiment, the acid value (mgKOH/g) of the rosin resin is about 5 or more, about 8 or more, or about 10 or more, and about 45 or less, about 30 or less, or about 20 or less. The acid value of the rosin resin may be determined in accordance with JIS K0070: 1992 (potentiometric titration method).

The usage of the tackifier may be about 0.1 parts by mass or more, about 0.5 parts by mass or more, or about 1 part by mass or more, and about 20 parts by mass or less, about 15 parts by mass or less, or about 12 parts by mass or less with respect to 100 parts by mass in total of the (meth)acrylic adhesive polymer and the self-crosslinking (meth)acrylic copolymer. When the usage of the tackifier is about 0.1 parts by mass or more with respect to 100 parts by mass in total of the (meth)acrylic adhesive polymer and the self-crosslinking (meth)acrylic copolymer, the initial tackiness of the adhesive layer can be effectively increased. When the usage of the tackifier is about 20 parts by mass or less 100 parts by mass in total of the (meth)acrylic adhesive polymer and the self-crosslinking (meth)acrylic copolymer, bleeding of an excess portion of the tackifier is prevented. Additionally, when the tackifier has an epoxy group-reactive functional group, the amount of the tackifier residue that remains after heat treatment without forming a chemical bond with the self-crosslinking (meth)acrylic copolymer is reduced, whereby the adhesive residue on the adherend can be more effectively reduced or eliminated.

The adhesive layer may include additives such as fillers such as talc, kaolin, calcium carbonate, aluminum flakes, fumed silica, alumina, and nanoparticles, antioxidants, and antistatic agents.

The presence and size of the sea-island structure of the adhesive layer can be measured using an atomic force microscope. In one embodiment, the maximum diameter of the island is about 20 nm or more, about 100 nm or more, or about 200 nm or more, and about 20 μm or less, about 10 μm or less, or about 1 μm or less. The “maximum diameter” in the present disclosure means a Krumbein diameter (maximum radial dimension in a constant direction).

The thickness of the adhesive layer may vary according to the application, and, for example, may be about 1 μm or more, about 5 μm or more, or about 25 μm or more, and about 250 μm or less, about 100 μm or less, or about 50 μm or less.

In one embodiment, the 180 degree peeling force of the heat-resistant laminate is about 0.9 N/cm or more, preferably about 1.2 N/cm or more, and more preferably about 1.5 N/cm or more when measured at a temperature of 60° C. and a peel rate of 300 mm/minute, after being adhered to the SUS plate and left for 30 minutes at 120° C. When a laminate of different materials is used as an adherend, since the 180 degree peeling force of the heat-resistant laminate measured under the above conditions is about 0.9 N/cm or higher, peeling of the adherend from the work surface due to warpage of the adherend can be more effectively prevented, and the adherend can be sufficiently fixed to a work surface such as SUS or quartz glass. In one embodiment, the 180 degree peeling force of the heat-resistant laminate is about 4 N/cm or less, about 3 N/cm or less, or about 2 N/cm or less when measured under the conditions described above.

In one embodiment, the 180 degree peeling force of the heat-resistant laminate is about 0.1 N/cm or more, preferably about 0.2 N/cm or more, and more preferably about 0.3 N/cm or more when measured at a temperature of 120° C. and a release rate of 300 mm/minutes after being adhered to the SUS plate and left for 30 minutes at 120° C. When the 180 degree peeling force of the heat-resistant laminate measured under the above conditions is about 0.1 N/cm or more, sufficient adhesive strength for fixing the adherend to the work surface during heat treatment can be obtained. In one embodiment, the 180 degree peeling force of the heat-resistant laminate is about 4 N/cm or less, about 3 N/cm or less, or about 2 N/cm or less, when measured under the conditions described above. When the 180 degree peeling force of the heat-resistant laminate measured under the above conditions is about 4 N/cm or less, the adherend can be easily peeled from the adhesive layer, and the adhesive residue on the adherend after removal can be reduced or eliminated.

The heat-resistant laminate may have a second adhesive layer on the substrate surface opposite to the substrate surface on which the adhesive layer is disposed. The second adhesive layer may be the same as the above adhesive layer, and may be formed with a commonly used (meth)acrylic, polyolefin, polyurethane, polyester, or rubber adhesive of solvent type, emulsion type, pressure-sensitive type, heat-sensitive type, thermosetting type, or UV-curable type. The thickness of the second adhesive layer may be generally about 5 μm or more, about 10 μm or more, or about 20 μm or more, and about 200 μm or less, about 100 μm or less, or about 80 μm or less.

A release liner may be disposed on the adhesive layer and/or the second adhesive layer. Examples of the release liner include sheets or films of paper (e.g., kraft paper) or polymer materials (e.g., polyolefins such as polyethylene, polypropylene, and polyesters such as ethylene vinyl acetate, polyurethane, and polyethylene terephthalate). The release liner may be subjected to a release treatment with a release agent including a silicone, a long-chain alkyl compound, a fluorine compound, or the like. The thickness of the release liner is generally about 5 μm or more, about 15 μm or more, or about 25 μm or more, and about 300 μm or less, about 200 μm or less, or about 150 μm or less.

In one embodiment, the heat-resistant laminate or its adhesive layer is used in a high temperature environment at 100° C. or higher. For example, in the solder reflow step, heat treatment is performed at a temperature of 100° C. to 270° C. for 5 minutes to 10 minutes, and in the curing step of the epoxy molding compound, heat treatment is performed at a temperature of 200° C. for 30 minutes to 2 hours. The heat-resistant laminate or its adhesive layer can be suitably used for such a high temperature heat treatment step.

The heat-resistant laminate can be suitably used as a process tape for temporary adhesion in a production process of electronic components and the like. Since the heat-resistant laminate can be formed from a non-siloxane material, problems such as contact failure caused by deposition of volatile low molecular siloxane on the electronic components and the like during heat treatment can be avoided.

### EXAMPLES

Although the illustrative embodiments of the present disclosure will be exemplified in the following Examples, the present invention is not limited to these embodiments. All parts and percentages are based on mass, unless otherwise stated.

The reagents and materials used in the Examples are shown in Table 1.

TABLE 1

| Item name, | | |
|---|---|---|
| name, or | | |
| abbreviation | Description | Suppliers |
| Acrylic | IOA/AA = 90/10, solid | — |
| adhesive | content 18%, toluene/ethyl | |
| polymer | acetate solution Mw | |
| | 1,200,000 | |
| Self- | 2EHA/AA/GMA = | — |
| crosslinking | 89/3.7/7.3, solid content | |
| acrylic | 29%, toluene/ethyl acetate | |
| copolymer | solution, containing 1% | |
| | by mass of Irganox | |
| | (trademark) 1330, | |
| | Mw 600,000 | |
| D-135 | Tackifier, polymerized | Arakawa Chemical |
| | rosin ester, acid value: | Industries, Ltd. |
| | 10 to 25, softening point | (Osaka-shi, Osaka, Japan) |
| | 135° C. | |
| IOA | IOA: isooctyl acrylate | BASF Japan Ltd. |
| | | (Minato-ku, Tokyo, Japan) |
| AA | AA: acrylic acid | BASF Japan Ltd. |
| | | (Minato-ku, Tokyo, Japan) |
| 2EHA | 2-ethylhexyl acrylate | Nippon Shokubai Co., Ltd. |
| | | (Osaka-shi, Osaka, Japan) |
| GMA | Glycidyl methacrylate | NOF CORPORATION |
| | | (Shibuya-ku, Tokyo, |
| | | Japan) |
| IPBMA | 1,1′-isophthaloylbis | — |
| | (2-methylaziridine), | |
| | 3% toluene solution | |
| Irganox | Antioxidant | BASF Japan Ltd. |
| (trademark) | | (Minato-ku, Tokyo) |
| 1330 | | |

### Example 1

A heat-resistant laminate having a pressure-sensitive adhesive layer on both surfaces was made using the following procedure.

An acrylic adhesive polymer, a self-crosslinking polymer, a tackifier D-135, and a crosslinking agent 1,1′-isophthaloylbis(2-methyl aziridine) (IPBMA) were mixed in a glass bottle according to the formulation described in Table 2. The mixture was diluted with methyl ethyl ketone (MEK) to prepare a pressure-sensitive adhesive solution with a solid content of 18% A 100-μm thick PET film (Lumirror (trademark) S10, manufactured by Toray Industries, Inc. (Chuo-ku, Tokyo, Japan)) or 25-μm thick polyimide (PI) film (Kapton (trademark) 100V, manufactured by DU PONT-TORAY CO., LTD. (Chuo-ku, Tokyo, Japan) was used as the film substrate of the heat-resistant laminate. The pressure-sensitive adhesive solution was cast on the surface of the film substrate, and dried in an oven at 65° C. for 2 minutes and at 100° C. for 2 minutes. The cast amount was adjusted so that the dry thickness of the pressure-sensitive adhesive layer was from 25 μm to 50 μm. A 38 μm-thick silicone-coated PET film (Cerapeel (trademark) BKE, manufactured by Toray Advanced Film Co., Ltd. (Chuo-ku, Tokyo, Japan)) was laminated on the first pressure-sensitive adhesive layer as a release liner.

100 g of an acrylic tacky polymer, 2.1 g of a tackifier D-135, and 0.2 g of a crosslinking agent IPBMA were mixed in a glass bottle. The mixture was diluted with MEK to prepare a pressure-sensitive adhesive solution with a solid content of 15% by mass. The pressure-sensitive adhesive solution was cast on the opposite surface (bottom surface) of the film substrate on which the first pressure-sensitive adhesive layer was formed, and then dried in an oven at 65° C. for 2 minutes and at 100° C. for 2 minutes. A silicone-coated PET film (Purex (trademark) A31, manufactured by Teijin Film Solutions Limited. (Chiyoda-ku, Tokyo, Japan)) was laminated on the second pressure-sensitive adhesive layer as a release liner.

Thereafter, the first pressure-sensitive adhesive layer and the second pressure-sensitive adhesive layer were further solidified by treating at 65° C. for 72 hours. In this manner, a heat-resistant laminate having a release liner on the first pressure-sensitive adhesive layer and the second pressure-sensitive adhesive layer was produced.

### Examples 2 to 4 and Comparative Examples 1 to 5

A first pressure-sensitive adhesive layer was formed according to the procedure described in Example 1, except that the components of the pressure-sensitive adhesive solution were changed. In Example 4, the thickness of the first pressure-sensitive adhesive layer was 50 μm, and the first pressure-sensitive adhesive layer was formed separately for 72 hours at 95° C. The formulation is shown in Table 2.

The heat-resistant laminates were evaluated for the following items.

180 Degree Peeling Force of the First Pressure-Sensitive Adhesive Layer

The release liner on the first pressure-sensitive adhesive layer was removed, and the first pressure-sensitive adhesive layer was placed on a SUS304 substrate at room temperature (23° C.). A 2-kg hand roller was reciprocated on the tape to adhere the tape to the SUS 304 substrate, thus making a 180 degree peel sample. The sample was aged in an oven at 120° C. for 30 minutes. The sample was cooled to room temperature (23° C.) over 15 minutes. The 180 degree peeling force was measured using a tensile tester at room temperature (23° C.) and 300 mm/minute. The 180 degree peeling force at 60° C. or 120° C. was similarly measured using a tensile tester equipped with an oven chamber.

Peeling of Laminate Substrate

The first pressure-sensitive adhesive layer of the heat-resistant laminate was adhered to the copper surface of a 120 μm thick copper clad laminate (CCL, copper foil thickness 40 μm) and cut into a 20 mm×50 mm rectangle. After removing the release liner from the second pressure-sensitive adhesive layer of the heat-resistant laminate, the second pressure-sensitive adhesive layer was adhered to a 1.0-mm thick glass plate. A 2-kg hand roller was reciprocated once on the copper clad laminate, and the copper clad laminate was pressed against the glass plate. The obtained sample was placed in an oven at 150° C. for 15 minutes and then cooled to room temperature for 15 minutes. The presence or absence of peeling of CCL from the heat-resistant laminate was observed with the naked eye. A sample in which no peeling was observed was defined as “good”, a sample slightly peeled only at the edge was determined as “acceptable”, and a sample largely peeled was defined as “poor”.

Pressure-Sensitive Adhesive Residue

The first pressure-sensitive adhesive layer of the heat-resistant laminate was adhered to the copper surface of CCL, and heat treated at 150° C. for 15 minutes or at 260° C. for 10 minutes. The CCL was detached from the heat-resistant laminate by pulling the CCL in the 90-degree direction using a handle on a 120° C. hot stage. After detachment, the presence or absence of pressure-sensitive adhesive residue on the copper surface of the CCL was observed with a 20-fold microscope. A sample in which no residue was observed was evaluated as “good”, and a sample in which residue was observed was evaluated as “poor”.

Evaluation results are shown in Table 2.

TABLE 2

| | | | | | | | | | | | Pressure- | |
|---|---|---|---|---|---|---|---|---|---|---|---|---|
| | First Pressure-sensitive adhesive layer | | | | | | | | | Laminate | sensitive | |
| | | Self- | | Cross- | | | 180 degree peeling | | | removal | adhesive | |
| | Acrylic | crosslinking | | linking | Thick- | | force (N/cm) | | | at | residue | |
| | adhesive | acrylic | Tackifier | agent | ness | Film | Room | | | 150° C., | 150° C., | 260° C., |
| | polymer | copolymer | D-135 | IPBMA | (μm) | substrate | temperature | 60° C. | 120° C. | 15 min | 15 min | 10 min |
| Example 1 | 62 | 36 | 2 | 0.7 | 30 | PET | 11 | 1.2 | 0.11 | good | good | N.A. |
| Example 2 | 62 | 36 | 2 | 0.7 | 30 | PI | 13 | 1.8 | 0.24 | good | good | good |
| Example 3 | 68 | 24 | 8 | 0.15 | 30 | PET | 8.6 | 2.3 | 0.32 | good | good | N.A. |
| Example 4 | 80 | 20 | — | — | 50 | PI | 2.5 | 0.9 | 0.5 | good | good | good |
| Comparative | 63 | 37 | — | 0.7 | 30 | PI | 1.3 | 0.47 | 0.09 | Good | good | good |
| Example 1 | | | | | | | | | | | | |
| Comparative | 100 | — | — | 0.7 | 25 | PI | 4.0 | 0.15 | 0.20 | Good | Poor | Poor |
| Example 2 | | | | | | | | | | | | |
| Comparative | — | 100 | — | — | 25 | PI | 1.0 | 0.11 | 0.08 | Poor | good | good |
| Example 3 | | | | | | | | | | | | |
| Comparative | 85 | — | 15 | 0.1 | 25 | PI | 16 | 10 | 2.2 | good | Poor | Poor |
| Example 4 | | | | | | | | | | | | |
| Comparative | — | 85 | 15 | — | 25 | PI | 5.0 | 0.8 | N/A | Poor | Poor | Poor |
| Example 5 | | | | | | | | | | | | |

It is clear to those skilled in the art that various modifications and changes can be made without deviating from the scope and spirit of the present invention.

### REFERENCE SIGNS LIST

10: Heat-resistant laminate

12: Substrate

14: Adhesive layer

142: Sea

144: Island

146: Tackifier having epoxy group-reactive functional group

16: Second adhesive layer

1. A heat-resistant laminate comprising: a substrate; and an adhesive layer, wherein the adhesive layer includes a (meth)acrylic adhesive polymer, and a self-crosslinking (meth)acrylic copolymer having an epoxy group and an epoxy group-reactive functional group, the adhesive layer has a sea-island structure including a sea including the (meth)acrylic adhesive polymer and an island including the self-crosslinking (meth)acrylic copolymer, and the laminate has a 180 degree peeling force of 0.9 N/cm or more after being adhered to a SUS board and left at 120° C. for 30 minutes as measured at a temperature of 60° C. and a peeling speed of 300 mm/min.

2. The laminate according to claim 1, wherein the adhesive layer further includes a tackifier having a softening point of 100° C. or higher.

3. The laminate according to claim 2, wherein the tackifier has an epoxy group-reactive functional group.

4. The laminate according to claim 1, wherein the self-crosslinking (meth)acrylic copolymer is a copolymer of a composition having from 50 to 98% by mass of alkyl (meth)acrylate, 1% by mass or more of an epoxy group-containing monomer, and 1% by mass or more of a monomer having an epoxy group-reactive functional group based on a polymerizable component.

5. The laminate according to claim 1, wherein the (meth)acrylic adhesive polymer is a copolymer of a composition having from 50 to 98% by mass of alkyl (meth)acrylate and a 2% by mass or more of a monomer having an epoxy group-reactive functional group based on a polymerizable component.

6. The laminate according to claim 1, wherein the adhesive layer includes the (meth)acrylic adhesive polymer and the self-crosslinking (meth)acrylic copolymer in a mass ratio of 99:1 to 51:49.

7. A heat-resistant laminate comprising: a substrate; and an adhesive layer, wherein the adhesive layer includes a (meth)acrylic adhesive polymer, a self-crosslinking (meth)acrylic copolymer having an epoxy group and an epoxy group-reactive functional group, and a tackifier having an epoxy group-reactive functional group, and the adhesive layer has a sea-island structure including a sea including the (meth)acrylic adhesive polymer and an island including the self-crosslinking (meth)acrylic copolymer.

8. The laminate according to claim 7, wherein the tackifier has a softening point of 100° C. or higher.

9. The laminate according to claim 7, wherein the self-crosslinking (meth)acrylic copolymer is a copolymer of a composition having 50 to 98% by mass of alkyl (meth)acrylate, 1% by mass or more of an epoxy group-containing monomer, and 1% by mass or more of a monomer having an epoxy group-reactive functional group based on a polymerizable component.

10. The laminate according to claim 7, wherein the (meth)acrylic adhesive polymer is a copolymer of a composition having 50 to 98% by mass of alkyl (meth)acrylate and 2% by mass or more of a monomer having an epoxy group-reactive functional group based on a polymerizable component.

11. The laminate according to claim 7, wherein the adhesive layer includes the (meth)acrylic adhesive polymer and the self-crosslinking (meth)acrylic copolymer in a mass ratio of 99:1 to 51:49.

12. A heat-resistant adhesive comprising: a (meth)acrylic adhesive polymer; a self-crosslinking (meth)acrylic copolymer having an epoxy group and an epoxy group-reactive functional group; and a tackifier having an epoxy group-reactive functional group, wherein the adhesive forms a sea-island structure including a sea including the (meth)acrylic adhesive polymer and an island including the self-crosslinking (meth)acrylic copolymer when solidified or dried on a substrate.

13. The adhesive according to claim 12, wherein the tackifier has a softening point of 100° C. or higher.

14. The adhesive according to claim 12, wherein the self-crosslinking (meth)acrylic copolymer is a copolymer of a composition having 50 to 98% by mass of alkyl (meth)acrylate, 1% by mass or more of an epoxy group-containing monomer, and 1% by mass or more of a monomer having an epoxy group-reactive functional group based on a polymerizable component.

15. The adhesive according to claim 12, wherein the (meth)acrylic adhesive polymer is a copolymer of a composition having 50 to 98% by mass of alkyl (meth)acrylate and 2% by mass or more of a monomer having an epoxy group-reactive functional group based on a polymerizable component.

16. The adhesive according to claim 12, including the (meth)acrylic adhesive polymer and the self-crosslinking (meth)acrylic copolymer in a mass ratio of 99:1 to 51:49.
